(19) United States
(12) Patent Application Publication
(10) Pub. No.: US 2008/0198514 A1
(43) Pub. Date: Aug. 21, 2008

(54) Magnetoresistive device, magnetic head, magnetic storage apparatus, and magnetic memory

(75) Inventors: Arata Jogo, Kawasaki (JP); Yutaka Shimizu, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki-shi (JP)

(21) Appl. No.: 12/068,892

(22) Filed: Feb. 13, 2008

(30) Foreign Application Priority Data
Feb. 19, 2007 (JP) 2007-038198

(51) Int. Cl. G11B 5/33

(52) U.S. Cl. 360/324.1

(57) ABSTRACT

A CPP-type magnetoresistive device includes a magnetization pinned layer, a magnetization free layer, and a non-magnetic layer provided between the magnetization pinned layer and the magnetization free layer. At least one of the magnetization free layer and the magnetization pinned layer is formed of CoFeGe, and the CoFeGe has a composition falling within a range defined by line segments connecting coordinate points A, B, C, and D in a ternary composition diagram where the point A is (42.5, 30, 27.5), the point B is (35, 52.5, 12.5), the point C is (57.5, 30.0, 12.5), and the point D is (45.0, 27.5, 27.5), and where each of the coordinate points is represented by content percentage of (Co, Fe, Ge) expressed by atomic percent (at. %).

### BACKGROUND OF THE INVENTION

1. Field of the Invention

The present invention relates to a magnetoresistive device used to reproduce information from a magnetic recording medium or storage devices, and more particularly, to a current-perpendicular-to-plane (CPP) magnetoresistive device in which a sense current flows in a direction of perpendicularly through multiplayer planes.

2. Description of the Related Art

In recent years and continuing, giant magnetoresistive (GMR) devices are used as information reproducing devices of the magnetic heads in magnetic storage apparatuses to reproduce information from magnetic recording media. The GMR device makes use of the giant magnetoresistive effect, which means change in resistance induced by an external magnetic field. With the GMR device, changes in direction of the magnetic field leaking from the magnetic recording medium are detected and converted into changes in electric resistance when reproducing information from the magnetic recording medium. Along with the development of high-density recording techniques, magnetoresistive devices using spin-valve film structures have become the mainstream. The spin-valve film structure is a multilayer structure including a magnetization pinned layer with its magnetization pinned or fixed in a predetermined direction, a non-magnetic layer, and a magnetization free layer with the magnetization rotatable in response to a direction or an intensity of a magnetic field leaking from a magnetic recording medium. The electric resistance of the spin-valve film structure changes according to the angle between the directions of the magnetization of the magnetization pinned layer and the magnetization free layer. By detecting the change in electric resistance as a voltage change under application of a sense current to the spin-valve film structure, bit values recorded in the magnetic recording medium are reproduced.

Conventionally, a CIP (current-in-plane) structure in which a sense current flows in the planar direction of the spin valves was used in magnetoresistive devices. However, it is currently required to increase the linear recording density and track density of magnetic recording media to achieve higher recording density. To keep pace with such demand, it is necessary for a magnetoresistive device to reduce the cross-sectional area defined by the device width (corresponding to the track width of the magnetic recording medium) and the device height (corresponding to the bit length in the magnetic recording medium). Since with a CIP structure the sense current is large, the device performance may be degraded due to migration in materials used in the spin-valve film structure.

To overcome this issue, CPP structures in which sense current flows perpendicularly through the magnetization pinned layer, the non-magnetic layer, and a magnetization free layer have been proposed. In fact, many studies and much research are being conducted on CPP magnetoresistive devices because of the potential as the next-generation information reproducing devices. The CPP spin-valve film structure is suitable for high-density recording because The output voltage is constant, even if the core width (which is the width of the spin valves corresponding to the track width of the magnetic recording medium) is reduced.

The output level of the CPP spin valves is determined by the amount of change in magnetoresistance per unit area occurring when an external magnetic field is applied to the spin valves by sweeping from one direction to the opposite direction. The amount of change in the magnetoresistance per unit area equals the product of the amount of change in the magnetoresistance of the spin valves and the area of the film of the spin valves. In order to increase the amount of magnetoresistance change per unit area, it is necessary to use a material having a large value of the product of the spin-dependent bulk scattering coefficient and the specific resistance for the magnetization free layer and the magnetization pinned layer. The spin-dependent bulk scattering is a phenomenon in which a degree of scattering of conduction electrons varies depending on the directions of spin of the conduction electrons in the magnetization free layer or the magnetization pinned layer. The amount of change in magnetoresistance increases as the spin-dependent bulk scattering coefficient increases. Examples of material with a large spin-dependent bulk scattering coefficient include (Co₂Fe)₁₀₀₋ₓGeₓ (0≦X≦30 at. %) and Co—Fe—Al. See, for example, JP 2006-73688 A.

However, even if the above-described materials are applied to the magnetization free layer or the magnetization pinned layer, the sensitivity to the change in magnetoresistance will be insufficient if the read gap is further narrowed along with the improvement of the recording density in the future.

### SUMMARY OF THE INVENTION

In one aspect of an embodiment, a current-perpendicular-to-plane (CPP) magnetoresistive device includes a magnetization pinned layer, a magnetization free layer, and a non-magnetic layer inserted between the magnetization pinned layer and the magnetization free layer, and at least one of the magnetization free layer and the magnetization pinned layer is formed of CoFeGe with a composition falling within the range defined by line segments connecting coordinate points A, B, C, and D in a ternary composition diagram with three axes of representing a cobalt (Co) composition, an iron (Fe) composition, and a germanium (Ge) composition expressed by atomic percentage (at. %), where point A is (42.5, 30, 27.5), point B is (35, 52.5, 12.5), point C is (57.5, 30, 12.5), and point D is (45.0, 27.5, 27.5).

### BRIEF DESCRIPTION OF THE DRAWINGS

FIG. 1 illustrates the major part of the functional surface of a magnetic head facing the recording medium according to the first embodiment of the invention;

FIG. 2 illustrates a cross-sectional structure of Example 1 of the GMR film configuring a magnetoresistive device of the first embodiment of the invention;

FIG. 3 illustrates a cross-sectional structure of Example 2 of the GMR film configuring a magnetoresistive device of the first embodiment of the invention;

FIG. 4 illustrates a cross-sectional structure of Example 3 of the GMR film configuring a magnetoresistive device of the first embodiment of the invention;

FIG. 5 illustrates a cross-sectional structure of Example 4 of the GMR film configuring a magnetoresistive device of the first embodiment of the invention;

FIG. 6 illustrates a cross-sectional structure of Example 5 of the GMR film configuring a magnetoresistive device of the first embodiment of the invention;

FIG. 7 illustrates a cross-sectional structure of Example 6 of the GMR film configuring a magnetoresistive device of the first embodiment of the invention;

FIG. 8 is a table showing compositions and MR ratio of various samples of the magnetization free layer of the GMR film of Example 2;

FIG. 9 is a ternary composition diagram showing the preferred range of the composition of the CoFeGe film used for the magnetization free layer;

FIG. 10 illustrates a cross-sectional structure of Example 1 of the TMR film configuring a magnetoresistive device of the second embodiment of the invention;

FIG. 11 illustrates a cross-sectional structure of Example 2 of the TMR film configuring a magnetoresistive device of the second embodiment of the invention;

FIG. 12 illustrates a cross-sectional structure of Example 3 of the TMR film configuring a magnetoresistive device of the second embodiment of the invention;

FIG. 13 illustrates a cross-sectional structure of Example 4 of the TMR film configuring a magnetoresistive device of the second embodiment of the invention;

FIG. 14 illustrates a cross-sectional structure of Example 5 of the TMR film configuring a magnetoresistive device of the second embodiment of the invention;

FIG. 15 illustrates a cross-sectional structure of Example 6 of the TMR film configuring a magnetoresistive device of the second embodiment of the invention;

FIG. 16 is a schematic plan view of the major part of a magnetic storage apparatus according to the third embodiment of the invention;

FIG. 17A is a schematic cross-sectional view of Example 1 of a magnetic memory according to the fourth embodiment of the invention:

FIG. 17B is a schematic diagram illustrating the structure of the GMR film used in the magnetic memory shown in FIG. 17A;

FIG. 18 is an equivalent circuit diagram of a memory cell of magnetic memory Example 1 shown in FIG. 17A;

FIG. 19 illustrates a cross-sectional structure of the TMR film used in a modification of Example 1 shown in FIG. 17A; and

FIG. 20 is a schematic cross-sectional view of Example 2 of a magnetic memory according to the fourth embodiment of the invention.

### DETAILED DESCRIPTION OF THE PREFERRED EMBODIMENTS

Details of the preferred embodiments are now described with reference to the attached drawings. The embodiments provide a high-output, high-sensitivity magnetoresistive device with a high MR ratio, which device is capable of maintaining sufficient sensitivity to the change in magnetoresistance. The embodiments also provide applications of the magnetoresistive device, including a magnetic head, a magnetic storage apparatus, and a magnetic memory. For these purposes, at least one of the magnetization free layer and the magnetization pinned layer of the magnetoresistive device is formed of CoFeGe with a specific range of composition. In the description, an “amount of change ΔRA in magnetoresistance per unit area” may be referred to as a “magnetoresistance change ΔRA” or simply as “ΔRA”.

### First Embodiment

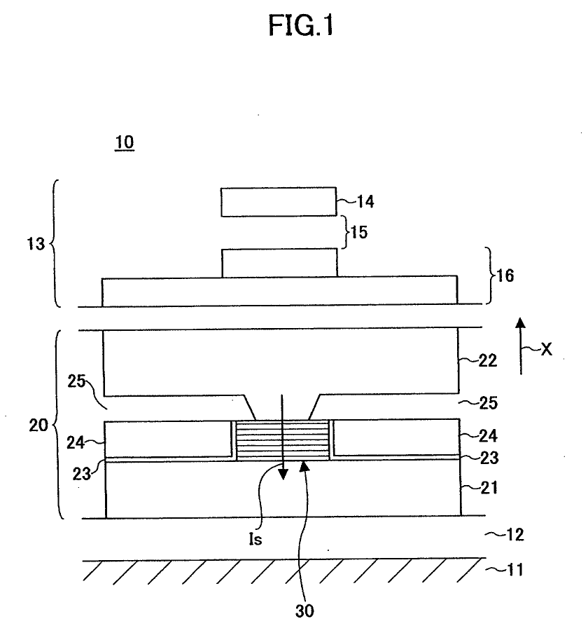

FIG. 1 is a schematic diagram illustrating the cross-sectional structure of a hybrid magnetic head 10 according to the first embodiment of the invention. The magnetic head 10 has a magnetoresistive device 20 and an induction type writing device 13. The arrow X represents a direction of movement of a magnetic recording medium (not shown) that faces the magnetoresistive device. The magnetoresistive device 20 is formed on a flat ceramic (e.g., Al₂O₃—TiC) substrate 11 that serves as the base of a head slider (not shown). On the magnetoresistive device 20 is formed the induction type writing device 13.

The induction type writing device 13 includes a top magnetic pole 14 having a width corresponding to the track width of the facing magnetic recording medium, a bottom magnetic pole 16 extending parallel to the top magnetic pole 14, and a writing gap layer 15 formed of a non-magnetic material and inserted between the top and bottom magnetic poles 14 and 16. The induction type writing device 13 also includes a yoke (not shown) magnetically connecting the top and bottom magnetic poles 14 and 16, and a coil (not shown) winding around the yoke. Electric writing current flowing through the coil induces a magnetic field for writing information. The top magnetic pole 14, the bottom magnetic pole 16, and the yoke are formed of a soft magnetic material. The soft magnetic material is preferably selected from materials with a large saturation magnetic flux density so as to guarantee a required recording magnetic field, and examples of such materials include Ni₈₀Fe, CoZrNb, FeN, FeSiN, FeCo, CoNiFe, etc. It should be noted that the induction type recording device 13 is not limited to the above-mentioned structure, and arbitrary known structures may be employed.

The magnetoresistive device 20 includes a bottom electrode 21, a magnetoresistive film 30 (hereinafter referred to as “GMR film 30”), an alumina film 25, and a top electrode 22 that are layered in this order on an alumina film 12 formed on the ceramic substrate 11. The GMR film 30 is electrically connected to each of the bottom electrode 21 and the top electrodes 22.

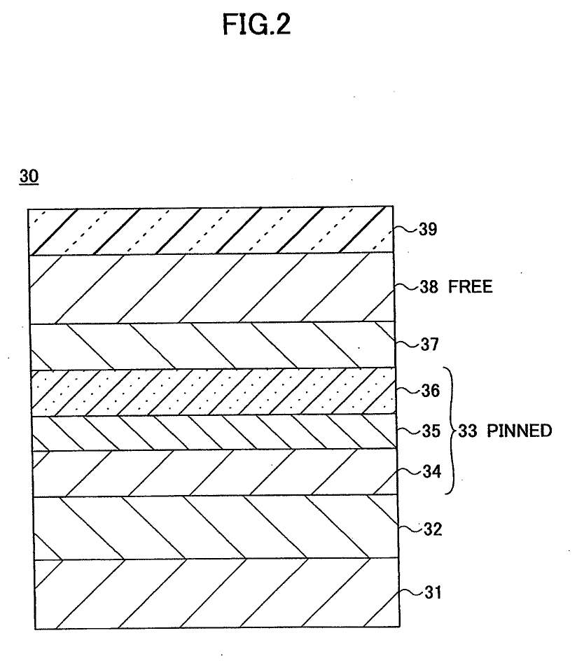

A magnetic-domain control film 24 is formed on each side of the GMR film 30 via an insulating film 23. The magnetic-domain control film 24 is a layered product of a Cr film, a CoCrPt, and CoPt film. The magnetic-domain control film 24 is provided to allow the magnetization free layer (shown in FIG. 2) in the GMR film 30 to have a single magnetic domain and prevent Barkhausen noise. The bottom electrode 21 and the top electrode 22 form an electric current path of a sense current Iₛ, and they also serve as magnetic shields. For this reason, the top electrode 21 and the top electrode 22 are formed of a soft magnetic material such as, for example, NiFe, CoFe, CoZrNb, FeN, FeSiN, CoNiFe, etc. Furthermore, an electrically conductive film, such as, for example, a Cu film, a Ta film, a Ti film, etc., may be provided to the boundary between the bottom electrode 21 and the GMR film 30. The magnetoresistive device 20 and the induction type writing device 13 are covered with an alumina film, a carbon hydride film, or other suitable film to prevent corrosion.

The sense current Iₛ flows through the GMR film 30, for example, from the top electrode 22, in a substantially vertical direction and reaches the bottom electrode 21. The magnetoresistance (electric resistance) of the GMR film 30 varies in response to the intensity and the direction of the signal magnetic field leaking from the magnetic recording medium. The magnetoresistive device 20 detects the change in the magnetoresistance of the GMR film 30 as a voltage change under application of a predetermined quantity of sense current Iₛ. Based upon the detected values, the magnetoresistive device 20 reproduces information from the magnetic recording medium. It should be noted that the direction of the flow of the sense current Iₛ is not necessarily the downward direction shown in FIG. 1, and it may be a reversed direction. The moving direction of the magnetic recording medium may also be reversed.

FIG. 2 is a cross-sectional view of the GMR film of the first example (Example 1) used in a magnetoresistive device according to the first embodiment of the invention. The GMR film 30 of Example 1 has a so-called single spin valve structure in which a buffer layer 31, an antiferromagnetic layer 32, a magnetization pinned layered product 33, a non-magnetic metal layer 37, a magnetization free layer 38, and a protection layer 39 are successively deposited in this order. The buffer layer 31 is formed on a surface of the bottom electrode 21 (see FIG. 1) by a sputtering method or other suitable methods. The buffer layer 31 is, for example, a NiCr film, a layered product of a Ta film and a Ru film, or a layered product of Ta film (with a thickness of 5 nm, for example) and a NiFe film (with a thickness of 5 nm, for example). In the latter case, the Fe content of the NiFe film is preferably in the range from 17 at. % to 25 at. %. Using the NiFe film or the Ru film, the antiferromagnetic layer 32 epitaxially grows on the (111) crystal plane, which is the direction of crystal growth of the NiFe film and the Ru film, and the crystallographically equivalent crystal planes. Consequently, the crystallinity of the antiferromagnetic layer 32 is improved.

The antiferromagnetic layer 32 is formed of, for example, a Mn-TM alloy (TM includes at least one of Pt, Pd, Ni, Ir and Rh) having a film thickness of 4 nm to 30 nm, and more preferably, 4 nm to 10 nm. Examples of the Mn-TM alloy include PtMn, PdMn, NiMn, IrMn, and PtPdMn. The antiferromagnetic layer 32 exerts an exchange interaction on the first magnetization pinned layer 34 of the magnetization pinned layered product 33, and fixes the magnetization of the first magnetization pinned layer 34 in a predetermined direction. The magnetization pinned layered product 33 includes a so-called synthetic Ferri pinned structure in which the first magnetization pinned layer 34, a non-magnetic coupling layer 35 and a second magnetization pinned layer 36 are deposited in this order from the antiferromagnetic layer 32. In the magnetization pinned layered product 33, the magnetization of the first magnetization pinned layer 34 and the magnetization of the second magnetization pinned layer 36 are exchange-coupled in an antiferromagnetic, and the directions of magnetization are opposite to each other.

Each of the first and second magnetization pinned layers 34 and 36 is formed of a ferromagnetic material containing at least one of Co, Ni and Fe, and has a thickness of 1 to 30 nm. Examples of the suitable ferromagnetic material for the first and second magnetization pinned layers 34 and 36 include CoFe, CoFeB, CoFeAl, NiFe, FeCoCu, CoNiFe, etc. The first and second magnetization pinned layers 34 and 36 are not necessarily single-layer films, and each of them may be a layered product of two or more films. In this case, the layered products may be of the same combination of the elements but with different composition ratios, or alternatively, they may be of combinations of different elements.

The second magnetization pinned layer 36 is preferably formed of CoFeAl or CoFeGe because of the following reasons. The spin-dependent bulk scattering coefficients β of CoFeAl and CoFeGe are similar to that of CoFe, which is a soft magnetic material, and have relatively large values as compared with the spin-dependent bulk scattering coefficients of other soft magnetic materials. For example, the spin-dependent bulk scattering coefficient β of Co₉₀Fe₁₀ is 0.55, while the spin-dependent bulk scattering coefficient β of Co₅₀Fe₂₀Al₃₀ is 0.50. In addition, the resistivity ρ of CoFeAl and CoFeGe are much greater than that of CoFe. For example, the resistivity of Co₉₀Fe₁₀ is 20 μΩcm, while the resistivity of Co₅₀Fe₂₀Al₃₀is 130 μΩcm, which is 6 times as great as Co₉₀Fe₁₀, and that of Co₅₀Fe₂₀Ge₃₀ is 236 μΩcm, which is greater than 11 times. Because the magnetoresistance change ΔRA depends on the product of spin-dependent bulk scattering coefficient β and specific resistance ρ, the ΔRA values of CoFeAl and CoFeGe are much greater than that of CoFe. Accordingly, the ΔRA value can be greatly increased by using CoFeAl or CoFeGe in the second magnetization pinned layer 36. In this case, it is desirable that the spin-dependent bulk scattering coefficients β of the CoFeGe film and the CoFeAl film be equal to or greater than 0.4 (β≧0.4).

Somce the resistivity ρ of CoFeAl and CoFeGe are not so dependent on the composition ratio, compositions of these materials can be easily controlled during the device fabrication, which is advantageous. Because of the above-described advantages, CoFeAl and CoFeGe can also be applied to the magnetization free layer 38.

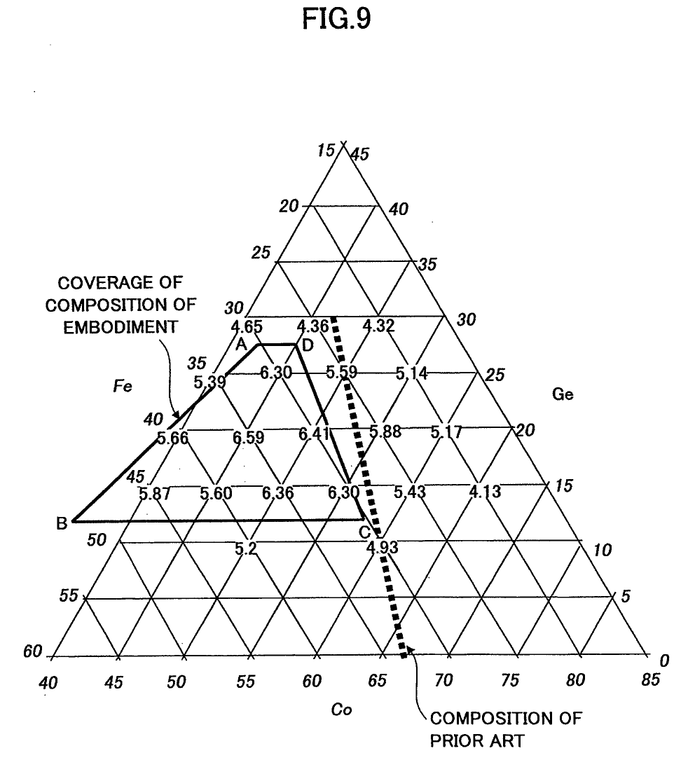

When the second magnetization pinned layer 36 is made of CoFeGe, it is preferable from the viewpoint of increasing the ΔRA value (which denotes the change in mangetoresistance) that the composition of CoFeGe resides in the area defined by the lines connecting the coordinate points A, B, C and D in the ternary composition diagram shown in FIG. 9, where the coordinate point is defined by the compositions of (Co, Fe, Ge) represented by atomic percent (at. %), and where point A is (42.5, 30, 27.5), point B is (35, 52.5, 12.5), point C is (57.5, 30, 12.5), and point D is (45.0, 27.5, 27.5).

Examples of the soft magnetic material used in the first magnetization pinned layer 34 include Co₆₀Fe₄₀ and NiFe, which are suitable in consideration of the low specific resistance. Since the magnetization of the first magnetization pinned layer 34 is opposite to that of the second magnetization pinned layer 36, the first magnetization pinned layer 34 acts to reduce the ΔRA value. The decrease in the ΔRA value can be prevented by using a ferromagnetic material with a small specific resistance.

The thickness of the non-magnetic coupling layer 35 is within a range in which the first magnetization pinned layer 34 and the second magnetization pinned layer 36 are exchange coupled antiferromagnetically. The range is 0.4 nm to 1.5 nm (more preferably 0.4 nm to 0.9 nm). The non-magnetic coupling layer 35 is formed of a non-magnetic material such as Ru, Rh, Ir, a Ru-based alloy, a Rh-based alloy, an Ir-based alloy, etc. The Ru-based alloy is preferably a combination of Ru and one or more materials selected from Co, Cr, Fe, Ni and Mn.

Although not specifically illustrated in the figure, a ferromagnetic joining layer with a higher saturation magnetic flux density than the first magnetization pinned layer 34 may be inserted between the antiferromagnetic layer 32 and the first magnetization pinned layer 34. This arrangement can increase the exchange interaction between the first magnetization pinned layer 34 and the antiferromagnetic layer 32, and prevent the undesirable situation where the magnetization of the first magnetization pinned layer 34 is offset or reversed from a predetermined direction.

The non-magnetic metal layer 37 is formed of an electrically conductive, non-magnetic material having a film thickness of, for example, 1.5 nm to 10 nm. Examples of the electrically conductive material suitably applied to the non-magnetic metal layer 37 include Cu, Al, etc.

The magnetization free layer 38 is provided over the non-magnetic metal layer 37, and is formed of CoFeGe with a film thickness of, for example, 2 nm to 12 nm. As mentioned above, CoFeGe has a spin-dependent bulk scattering coefficient similar to that of CoFe, and has a specific resistance much greater than that of CoFe. Consequently, the ΔRA value of the magnetization free layer 38 can be increased, compared with a CoFe free magnetization layer. Preferably, the composition of CoFeGe is selected so as to be within the area defined by the lines connecting coordinate points A, B, C, and D in the ternary composition diagram shown in FIG. 9, where point A is (42.5, 30, 27.5), point B is (35, 52.5, 12.5), point C is (57.5, 30, 12.5), and point D is (45.0, 27.5, 27.5). In this case, a ΔRA value (the change in magnetoresistance) greater than that of (Co2Fe)₁₀₀₋ₓGeₓ (0≦X≦30 at. %), which is a known Heusler alloy, can be achieved, and consequently, a magnetoresistive device with a high output level can be realized.

The CoFeGe layer with the above-described composition range, which is applied to at least one of the magnetization pined (ferromagnetic) layer and the magnetization free layer, may be used by a sputtering process using a CoFeGe-alloy target with a predetermined composition, or three separate targets of Co, Fe, and Ge. In the latter case, the three targets may be used in a co-sputtering process, or they may be used alternately to form a multilayer structure of CoFeGe. In another alternative, a single target may be combined with a two-element alloy target, and the targets may used either in a simultaneous discharge process or in a multi-layering process. For example, a Co target and a FeGe alloy target may be used in co-sputtering or multi-layering.

The protection layer 39 is formed of a non-magnetic, electrically conductive material, such as a metal containing any one of Ru, Cu, Ta, Au, Al and W, and it may have a multilayer structure of these materials. The protection layer 39 prevents oxidation of the magnetization free layer 38 when performing a heat treatment to bring out the antiferromagnetism of the antiferromagnetic layer 32 explained below.

Next, explanation is made of formation of the GMR film 30 of structural example 1 in conjunction with FIG. 2. First, each of the layers from the buffer layer 31 up to the protection layer 39 is formed by a sputter method, a vapor deposition method, a CVD method, or other suitable methods, using the above-described materials, to produce a multilayer structure.

Then, the multilayer structure is heated in a magnetic field. The conditions of the heating process are heating at 250° C. to 320° C. for about 2 to 4 hours in a vacuum atmosphere under the application of the magnetic field of 1592 kA/m. During the heating process, a part of the Mn-TM alloy turns to a ordered alloy, and antiferromagnetism comes in. By applying a magnetic field in a predetermined direction during the heating process, the direction of magnetization of the antiferromagnetic layer 32 is set in a predetermined direction, and as a result, the magnetization of the pinned layer 33 can be fixed in a desired direction making use of the exchange interaction between the antiferromagnetic layer 32 and the magnetization pinned layer 33.

Then, the multilayer structure from the buffer layer 31 to the protection layer 39 is patterned in a predetermined shape to obtain the GMR film 30, as shown in FIG. 1. The GMR films used in the subsequent structural examples 1-6 described below are also formed in the same method as the GMR film 30 of this example. Since the magnetization free layer 38 of the subsequent structural examples are also formed of CoFeGe, as in the structural example 1, the GMR film structure with a great ΔRA value can be obtained, and consequently, a high-output level magnetoresistive device can be achieved.

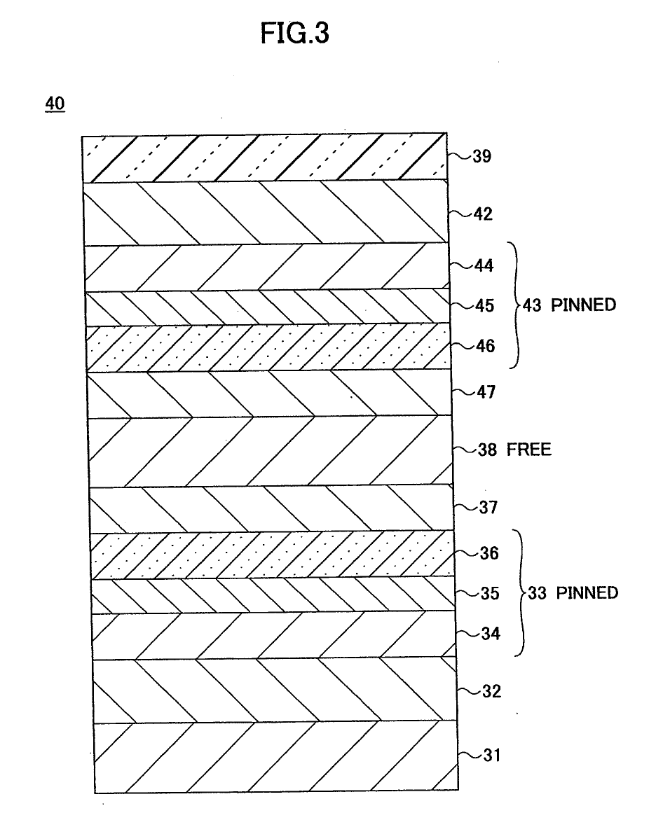

FIG. 3 is a cross-sectional view of the GMR film 40 of structural example 2 applied to the magnetoresistive device 20 of the first embodiment of the present invention. In FIG. 3, the same elements as those shown in FIG. 2 are denoted by the same symbols, and explanation for them is omitted.

The GMR film 40 of structural example 2 includes a buffer layer 31, a lower antiferromagnetism layer 32, a lower magnetization pinned layered product 33, a lower non-magnetic metal layer 37, the magnetization free layer 38, an upper non-magnetic metal layer 47, an upper magnetization pinned layered product 43, an upper antiferromagnetic layer 42, and a protection layer 39 deposited successively in this order from the bottom. The GMR film 40 has a so-called dual spin valve structure in which the upper non-magnetic metal layer 47, the upper magnetization pinned layered product 43, and the upper antiferromagnetic layer 42 are inserted between the magnetization free layer 38 and the protection layer 39 of the GMR film 30 of the structural example 1 shown in FIG. 2. Since the lower antiferromagnetic layer 32, the lower magnetization pinned layered product 33, and the lower non-magnetic metal layer 34 are formed of the same materials and have the same film thicknesses as the antiferromagnetic layer 32, the magnetization pinned layer 33 and the non-magnetic metal layer 34, respectively, of the GMR film 30 of the structural example 1 shown in FIG. 2, they are denoted by the same symbols. The upper non-magnetic metal layer 47 and the upper antiferromagnetic layer 42 can be formed of the same materials as the lower non-magnetic metal layer 37 and the lower antiferromagnetic layer 32, respectively, and the film thicknesses can also be set in the same range. The upper magnetization pinned layered product 43 has a so-called synthetic Ferri pinned structure in which the upper first magnetization pinned layer 44, the upper non-magnetic joining layer 45 and the second magnetization pinned layer 46 are layered successively in this order from the upper antiferromagnetic layer 42. The upper first magnetization pinned layer 44, the upper non-magnetic joining layer 45 and the second magnetization pinned layer 46 can be formed by the same materials as the lower first magnetization pinned layer 34, the lower non-magnetic joining layer 35 and the lower second magnetization pinned layer 36, respectively, and the film thicknesses are also set in the same range.

The magnetization free layer 38 of the GMR film 40 is made of CoFeGe with a suitable composition range determined in the same manner as the magnetization free layer 38 of the GMR film 30 shown in FIG. 2, and the magnetoresistive device 20 with the GMR film 40 has a large amount of magnetoresistance change ΔRA for the same reason as in the structural example 1. In addition, the GMR film 40 has a dual spin valve structure including a lower spin valve with the lower magnetization pinned layered product 33, the lower non-magnetic metal layer 37 and the magnetization free layer 38, and an upper spin valve with the magnetization free layer 38, the upper non-magnetic metal layer 47 and the upper magnetization pinned layered product 43. Consequently, the total amount of magnetoresistance change ΔRA of the GMR film 40 is increased up to twice the ΔRA value of the GMR film 30 of the structural example 1. When applying the GMR film 40 to the magnetoresistive device, a higher output level is achieved in the magnetoresistive device, as compared with the application of the GMR film 30 of the structural example 1. It should be noted that the fabrication method of the GMR film 40 is the same as that of the GMR film 30 of the structural example 1, and that explanation for it is omitted here.

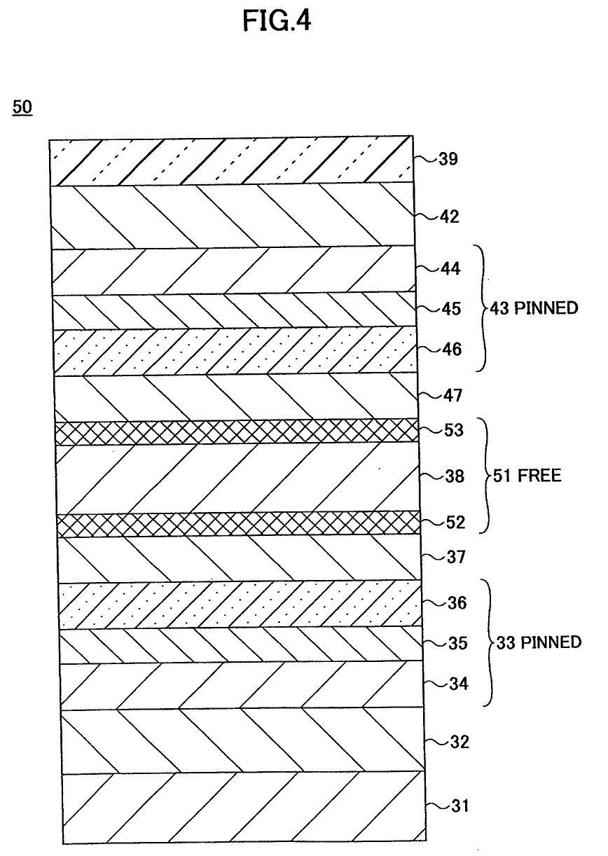

FIG. 4 is a cross-sectional view of the GMR film 50 of the structural example 3 applied to the magnetoresistive device 20 of the first embodiment of the present invention. The GMR film 50 of the structural example 3 is a modification of the GMR film 40 of the structural example 2, and it includes first and second interfacial magnetic layers 52 and 53 that sandwich the magnetization free layer 38. The first and second interfacial magnetic layers 52 and 53 prevent Germanium (Ge) atoms diffusing from the magnetization free layer 38 to the non-magnetic layers 37 and 47.

In other words, the GMR film 50 has a magnetization free layered product 51, in place of the magnetization free layer 38 of the GMR film 40 in FIG. 3 (structural example 2). To be more precise, the GMR film 50 includes a buffer layer 31, a lower antiferromagnetic layer 32, a lower magnetization pinned layered product 33, a lower non-magnetic metal layer 37, a magnetization free layered product 51, an upper non-magnetic metal layer 47, an upper magnetization pinned layered product 43, an upper antiferromagnetic layer 42, and a protection layer 39 deposited successively in this order from the bottom. The same elements as those shown in FIG. 3 are denoted by the same symbols, and explanation for them is omitted.

The magnetization free layered product 51 includes a first interfacial magnetic layer 52, a magnetization free layer 38, and a second interface magnetic layer 53 arranged in that order over the lower non-magnetic metal layer 37. The magnetization free layer 38 is formed of CoFeGe with the same composition range as that in the GMR film 30 of the structural example 1 shown in FIG. 2. Each of the first and second interfacial magnetic layers 52 and 53 is made of a soft magnetic material and has a thickness of, for example, 0.2 nm to 2.5 nm. Preferably, the first and second interfacial magnetic layers 52 and 53 are formed of a material with a spin-dependent interface scattering coefficient greater than that of CoFeGe. Examples of such a material include CoFe, a CoFe alloy, NiFe and a NiFe alloy. The CoFe alloy includes CoFeNi, CoFeCu, CoFeCr, CoFieAl etc. The NiFe alloy includes NiFeCu, NiFeCr, etc. The magnetoresistance change ΔRA of the magnetization free layered product 51 is improved by providing the pair of soft magnetic material films having a great spin-dependent interface scattering coefficient value so as to sandwich the magnetization free layer 38.

The first and second interfacial magnetic layers 52 and 53 may be formed of a same material with the same composition, a material containing the same elements but with different compositions, or alternatively, of different materials containing different elements. Furthermore, the first and second interfacial magnetic layers 52 and 53 may be made of CoFeGe with a composition ratio different from that of the magnetization free layer 38. For example, CoFeGe with a higher coercitivity than that of the magnetization free layer 38 may be used for the first and second interfacial magnetic layers 52 and 53.

The GMR film 50 of the structural example 3 has the same effect and advantages as the GMR film 40 of the structural example 2, and has an increased magnetoresistance change ΔRA because of the insertion of the first and second interfacial magnetic layers 52 and 53 sandwiching the magnetization free layer 38.

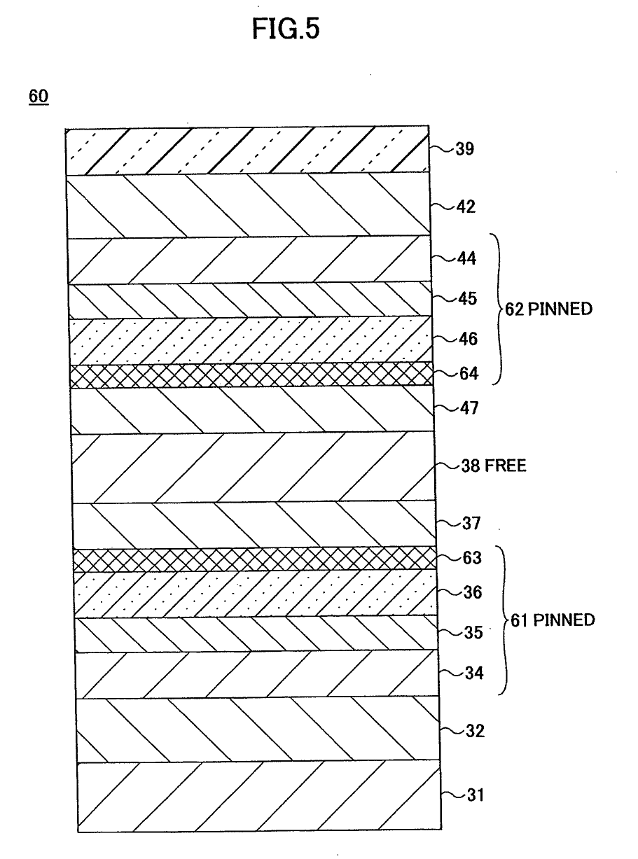

FIG. 5 is a cross-sectional view of the GMR film 60 of the structural example 4 applied to the magnetoresistive device 20 of the first embodiment of the present invention. The GMR film 60 of the structural example 4 is a modification of the GMR film 40 of structural example 2 shown in FIG. 3. The same elements as those shown in FIG. 3 are denoted by the same symbols, and explanation for them is omitted.

In GMR film 60 of the structural example 4, a third interfacial magnetic layer 63 is inserted between the second lower magnetization pinned layer 36 and the lower non-magnetic metal layer 37, and a fourth interfacial magnetic layer 64 is inserted between the second upper magnetization pinned layer 46 and the upper non-magnetic metal layer 47. In other words, the GMR film 60 has a lower magnetization pinned layered product 61 and an upper magnetization pinned layered product 62 in place of the lower magnetization pinned layered product 33 and the upper magnetization pinned layered product 43 of GMR film 40 of structural example 2 shown in FIG. 3. Accordingly, the GMR film 60 includes a buffer layer 31, a lower antiferromagnetic layer 32, a lower magnetization pinned layered product 61, a lower non-magnetic metal layer 37, a magnetization free layer 38, an upper non-magnetic metal layer 47, an upper magnetization pinned layered product 62, an upper antiferromagnetic layer 42, and a protection layer 39 deposited successively in this order from the bottom.

The lower magnetization layered product 61 includes a first interfacial magnetic layer 63 provided between the lower second magnetization layer 36 and the lower non-magnetic metal layer 37. The upper magnetization layered product 62 includes a second interfacial magnetic layer 64 provided between the upper non-magnetic metal layer 47 and the upper second magnetization layer 46. Each of the first and second interfacial magnetic layers 63 and 64 is formed of a ferromagnetic material, and has a thickness in the range from 0.2 nm to 2.5 nm. Preferably, each of the first and second interfacial magnetic layers 63 and 64 has a spin-dependent interface scattering coefficient greater than that of CoFeGe. Examples of such a material include CoFe, a CoFe alloy, NiFe and a NiFe alloy. CoFe alloy includes CoFeNi, CoFeCu, CoFeCr, CoFeAl etc. NiFe alloy includes NiFeCu, NiFeCr, etc. With this arrangement, the magnetoresistance change ΔRA can be increased.

The first and second interfacial magnetic layers 63 and 64 may be made of a same material with the same composition, or a material containing the same elements but with different compositions.

The GMR film 60 of the structural example 4 has the same effect and advantages as the GMR film 40 of the structural example 2, and has an improved magnetoresistance change ΔRA because of the first and second interfacial magnetic layers 63 and 64.

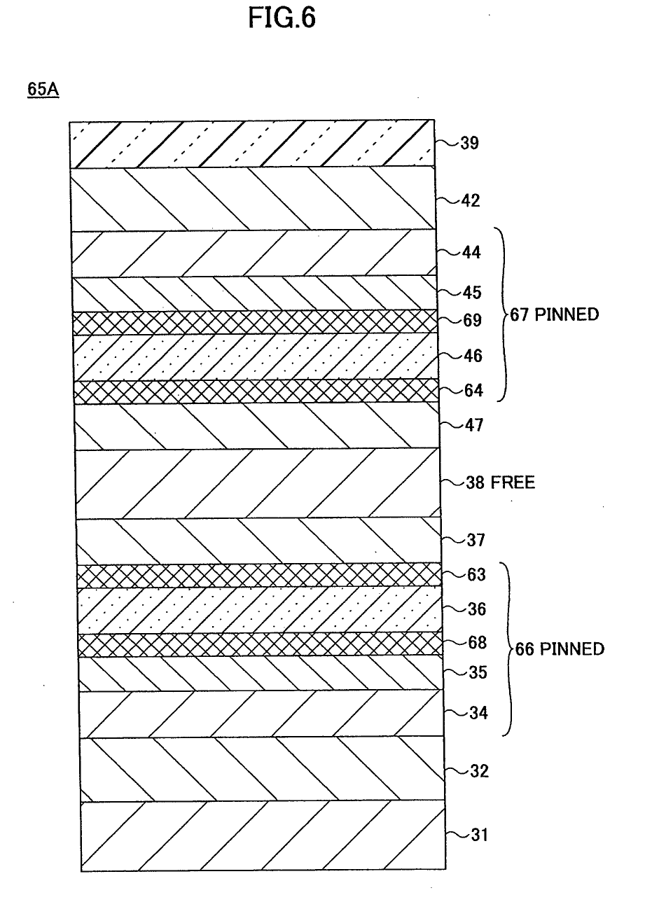

FIG. 6 is a cross-sectional view of the GMR film 65A of structural example 5 applied to the magnetoresistive device 20 of the first embodiment of the present invention. The GMR film 65A of this example is a modification of the GMR film 60 of the structural example 4. In this structure, the second lower magnetization pinned layer 36 is arranged between the second interfacial magnetic layer 63 and a first ferromagnetic joining layer 68, and the second upper magnetization pinned layer 46 is arranged between the third interfacial magnetic layer 64 and a fourth ferromagnetic joining layer 69.

The GMR film 65A of the structural example 5 includes a buffer layer 31, a lower antiferromagnetic layer 32, a lower magnetization pinned layered product 66, a lower non-magnetic metal layer 37, a magnetization free layer 38, an upper non-magnetic metal layer 47, an upper magnetization pinned layered product 67, an upper antiferromagnetic layer 42, and a protection layer 39 deposited successively in this order from the bottom. The lower magnetization pinned layered product 66 includes the first ferromagnetic joining layer 68 provided between the lower non-magnetic coupling layer 35 and the second lower magnetization pinned layer 36, and the upper magnetization pinned layered product 67 includes the second ferromagnetic joining layer 69 provided between the second upper magnetization pinned layer 46 and the upper non-magnetic coupling layer 45.

Each of the first and fourth ferromagnetic joining layers 68 and 69 has a thickness ranging from 0.2 nm to 2.5 nm, and is made of a ferromagnetic material containing at least one of Co, Ni and Fe. Examples of such a material include CoFe, CoFeB, and CoNiFe. The first ferromagnetic joining layer 68 and the forth ferromagnetic joining layer 69 are made of a ferromagnetic material with a saturation magnetization greater than that of the second lower magnetization pinned layer 36 and the second upper magnetization pinned layer 46, respectively. This arrangement increases the exchange coupling between the first ferromagnetic joining layer 68 and the first lower magnetization pinned layer 34, and between the forth ferromagnetic joining layer 69 and the first upper magnetization pinned layer 44. As a result, the direction of magnetization of the second lower magnetization pinned layer 36 and the second upper magnetization pinned layer 46 are stabilized, and the magnetoresistance change ΔRA becomes reliable.

The GMR film 65A of the structural example 5 has the same effect and advantages as the GMR film 60 of the structural example 4. In addition, the magnetoresistance change ΔRA becomes stable because of the insertion of the first and forth ferromagnetic joining layers 68 and 69.

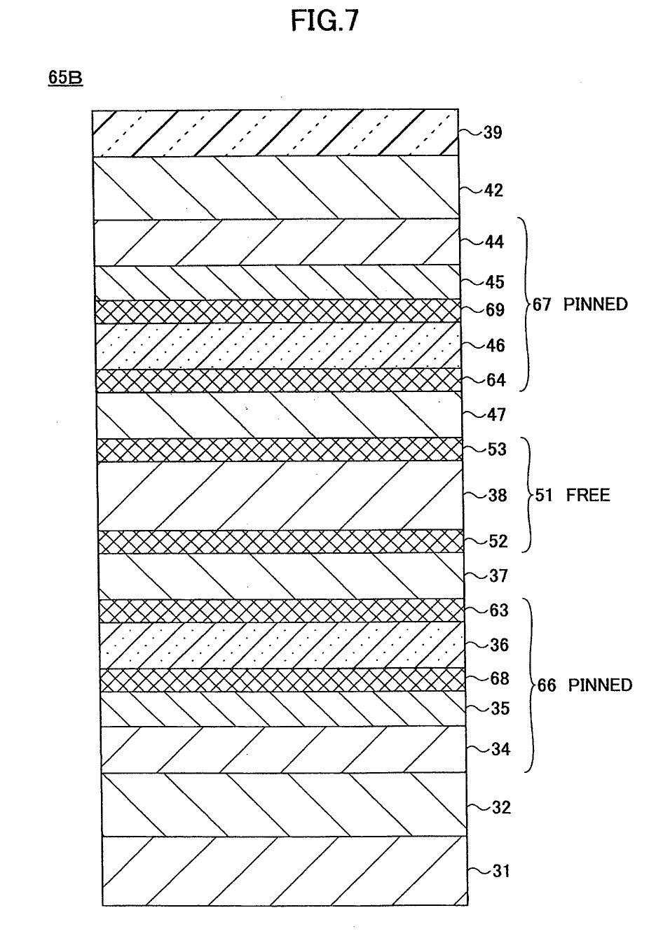

FIG. 7 is a cross-sectional view of the GMR film 65B of structural example 6 applied to the magnetoresistive device 20 of the first embodiment of the present invention. The GMR film 65B of this example is a combination of the GMR film 50 of the structural example 3 and the GMR film 65A of the structural example 5. The GMR film 65B includes a buffer layer 31, a lower antiferromagnetic layer 32, a lower magnetization pinned layered product 66, a lower non-magnetic metal layer 37, a magnetization free layered product 51, an upper non-magnetic metal layer 47, an upper magnetization pinned layered product 67, an upper antiferromagnetic layer 42, and a protection layer 39 deposited successively in this order from the bottom. The magnetization free layered product 51 arranged over the lower non-magnetic metal layer 37 includes a first interfacial magnetic layer 52, a magnetization free layer 38, and a second interfacial magnetic layer 53 deposited in this order from the bottom.

In this example, if the magnetization free layer 38, the second lower magnetization pinned layer 36, and the second upper magnetization pinned layer 46 are formed of CoFeGe, then interfacial magnetic layers 52, 53, 63 and 64 are inserted one per boundary in all the boundaries between these magnetization pinned layers and the non-magnetic metal layers 37 and 47. In addition, a first ferromagnetic joining layer 68 is inserted between the second lower magnetization pinned layer 36 and the lower non-magnetic coupling layer 35 in the lower magnetization pinned layered product 66, and a second ferromagnetic joining layer 69 is inserted between the second upper magnetization pinned layer 46 and the upper non-magnetic coupling layer 45 in the upper magnetization pinned layered product 67. This arrangement can increase and stabilize the magnetoresistance change ΔRA of the GMR film 65B most efficiently.

Although it is described in the first embodiment that the GMR films of the structural examples 3 through 6 are modifications of the dual spin valve GMR film 40 of the structural example 2, the arrangements of structural examples 3-6 may be applied to the magnetization free layer 38 and the second magnetization pinned layer 36 of the single spin valve GMR film 30 of structural example 1 shown in FIG. 2.

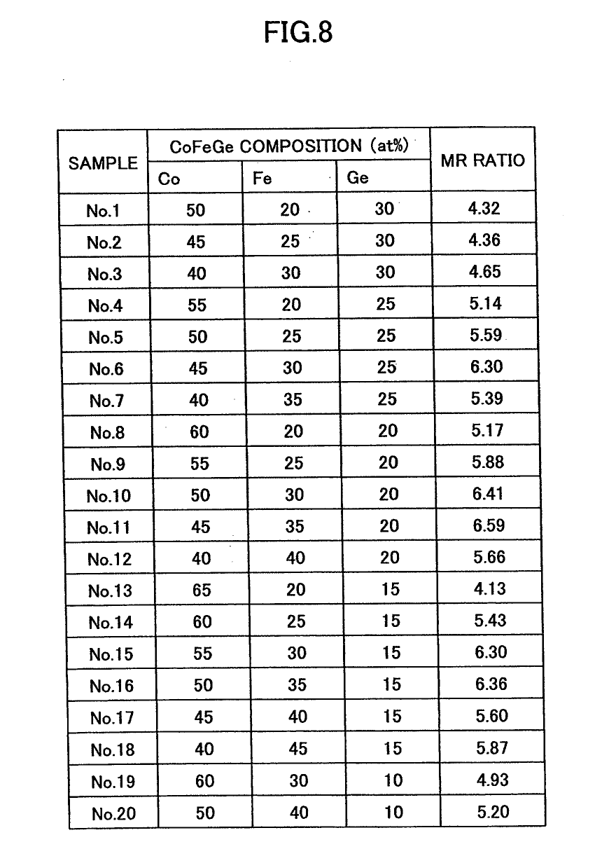

FIG. 8 is a table showing the measurement result of the MR ratios (%) of samples No. 1 through No. 20 with different CoFeGe compositions in the CoFeGe films serving as the magnetization free layer 38 of the GMR film 40 of structural example 2 shown in FIG. 3.

Each sample was fabricated as follows. A layered film of Cu(250 nm)/NiFe(50 nm) is formed as a bottom electrode 21 over a silicon substrate covered with a thermal oxidation film (see FIG. 1). Then, the layered product beginning from the buffer layer 31 up to the protection layer 39 was formed using a sputtering apparatus in a ultra-high vacuum atmosphere (equal to or lower than 2×10⁻⁶ Pa), without heating the substrate. The composition and the film thickness of each layer in the layered product are listed below. After deposition, heat treatment was applied to bring out the antiferromagnetism of the antiferromagnetic layer. The conditions of the heat treatment were heating at 300° C. for 3 hours under the application of the magnetic field of 1952 kA/m. Then, the multilayer structure was processed by ion milling and photolithography to produce a layered product. In the actual process, six types of layered products with different joining area sizes varying from 0.1 μm² to 0.6 μm² were fabricated, and forty (40) pieces of the layered product were fabricated for each of the joining area sizes.

Then, a silicon oxide film was formed over the layered product. The silicon oxide film was dry-etched to expose the protection layer, and an Au film was deposited to form a top electrode that is in contact with the protection layer. The material and the thickness (in the parenthesis) of each of the layers in the GMR film 40 used in the samples (No. 1 through No. 20) are presented below.
Buffer layer 31: Ru (4 nm)
Lower antiferromagnetic Layer 32: IrMn (7 nm)
First Lower magnetization pinned layer 34: Co₆₀Fe₄₀ (3.5 nm)
Lower non-magnetic coupling layer 35: Ru (0.7 nm)
Lower second magnetization pinned layer 36: CoFeAl (5.0 nm)
Lower non-magnetic metal layer 37: Cu (3.5 nm)
Magnetization free layer 38: CoFeGe (4.5 nm)
Upper non-magnetic metal layer 47: Cu (3.5 nm)
Second upper magnetization pinned layer 46: CoFeAl (3.0 nm)
Upper non-magnetic coupling layer 45: Ru (0.7 nm)
First upper magnetization pinned layer 44: Co₆₀Fe₄₀ (3.5 nm)
Upper antiferromagnetic layer 42: IrMn (7 nm)
Protection layer 39: Ru (5 nm)

The magnetoresistance change ΔR was measured for each of the samples (No. 1 through No. 20), and an average magnetoresistance (MR) ratio expressed by ΔRA/RA is calculated for each joining area size. In measuring the magnetoresistance change ΔR, the sense current was 2 mA, and an external magnetic field was swept from −79 kA/m to 79 kA/m parallel to the direction of magnetization of the upper and lower second magnetization pinned layers 36 and 36. A voltage between the bottom electrode and the top electrode was measured by a digital voltage meter to obtain a magnetic resistance curve. Then, magnetoresistance change ΔR is calculated from the difference between the maximum value and the minimum value of the magnetic resistance curve. The coercive force of the magnetization free layer 38 was also estimated from the hysteresis of the magnetic resistance curve acquired by sweeping the external magnetic field in the range of −7.9 kA/m to 7.9 kA/m in the direction described above.

From the table of FIG. 8, it is interpreted that the ΔRA was at or above 5 mΩμm² in the samples No. 1 to No. 20, or the MR ratio is at or above 5%. According to the study by the inventors, the magnetoresistance changes of samples No. 1 through No. 20 are greater than that of a conventional structure having a CoFe magnetization free layer. Such a satisfactory MR ratio can be acquired when the CoFeGe film is applied to at least one of the second upper magnetization pinned layer 46 and the second lower magnetization pinned layer 36.

FIG. 9 is a ternary composition diagram of Co, Fe, and Ge showing a composition range of the magnetization free layer 38, in which diagram the MR ratios (%) of the samples (No. 1 through No. 20) are plotted at coordinate points corresponding to the compositions. The compositions and the corresponding MR ratios of a known Heusler alloy are also plotted in the thick dashed line for comparison purpose.

The MR ratio of Co₅₀Fe₂₅Ge₂₅ of the known Heusler alloy is maximum 5.59%. In contrast, the CoFeGe magnetization free layer 38 having the composition within the range defined by the area ABCD according to the embodiment can achieve the MR ratio at or above 5.6%. Especially those samples with higher Fe composition and lower Ge composition show satisfactorily high MR ratios. It is clearly understood that the GMR film 40 of structural example 2 having the composition range defined by area ABCD is superior with higher MR ratio, compared with the conventional alloy (Co2Fe)₁₀₀₋ₓGeₓ, where 0≦X≦30 at. %.

In conclusion, the preferable composition range of CoFeGe applied to the magnetization free layer 38 is within the area connecting the coordinate points A, B, C, and D, assuming that each coordinate point represents the content percentages of (Co, Fe, Ge), where point A is (42.5, 30, 27.5), point B is (35, 52.5, 12.5), point C is (57.5, 30.0, 12.5), and point D (45.0, 27.5, 27.5). This composition range can achieve a MR ratio higher than that of Co₅₀Fe₂₅Ge₂₅, which is the composition of Heusler alloy, and improve the output with respect to the signal magnetic field.

It is confirmed by the experiment that the MR ratio can be improved up to a maximum 8.39% when the multilayer structure of example 6 shown in FIG. 7 is employed, and when Co₄₅Fe₃₅Ge₂₀ is applied to lower and upper second magnetization pined layers 36 and 46, as well as to the magnetization free layer 38, with CoFe interfacial magnetic layers arranged at all the boundaries with the CoFeGe films. From this result, it is appreciated that diffusion of Ge atoms is prevented and a high MR ratio is achieved when interfacial magnetic layers (e.g., CoFe layers) are inserted between any one of the CoFeGe films and each of the non-magnetic layers 37 and 47.

CoFeGe has a spin-dependent bulk scattering coefficient as great as that of CoFe, which value is greater than that of other soft magnetic materials. In addition, the resistivity of CoFeGe is eight times that of CoFe or more. By applying CoFeGe to at least one of the magnetization free layer 38 and the magnetization pinned layer 36 (or 46) that is in contact with the non-magnetic metal layer 37 (or 47), the magnetoresistance change determined by the product of the spin-dependent bulk scattering coefficient and the specific resistance becomes relatively high, compared with CoFe. Consequently, the output level of the magnetoresistive device 20 can be increased.

In this manner, the magnetoresistive device 20 which uses CoFeGe with the composition range defined by the area ABCD in the ternary composition diagram is applied to at least one of the magnetization free layer 38 and the magnetization pinned layer 36 (or 47) in contact with the non-magnetic metal layer 37 (or 47), has a great ΔRA value representing the magnetoresistance change per unit area, and realizes a high output level. As the Ge composition is increased, the specific resistance is increased; however, if the Ge composition exceeds 27.5%, the magnetic moment abruptly decreases, and as a result, the MR ratio decreases. On the other hand, if the Ge composition is below 12.5%, the specific resistance cannot be satisfactory compared with CoFe, and the MR ratio can not be increased. Accordingly, the preferred range of the Ge composition is from 12.5% to 27.5%.

### Second Embodiment

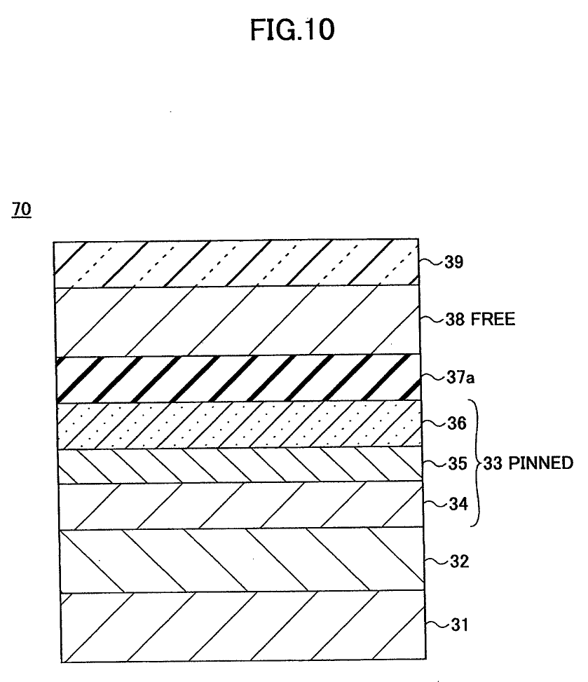

FIG. 10 is a schematic cross-sectional diagram of a magnetoresistive effect film applied to a magnetic head according to the second embodiment of the invention. In the second embodiment, a tunnel magnetoresistive film (hereinafter, referred to as a TMR film) is applied in place of the GMR film of the first embodiment to the magnetoresistive device, and other structures and arrangements are the same as those in the first embodiment. Accordingly, explanation for the magnetic head is omitted here.

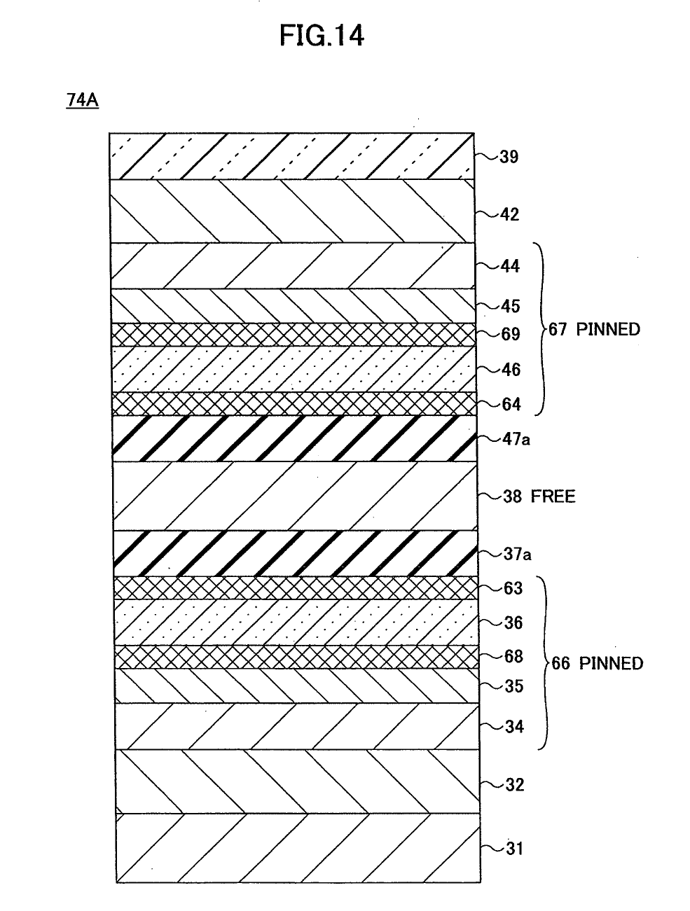

FIGS. 10-15 illustrate structural examples 1-6 of the TMR film used in the magnetoresistive device 20 of the second embodiment. The TMR films 70, 71, 72, 73, 74A and 74B of the structural examples 1-6 of the second embodiment have the same structures as the GMR films 30, 40, 50, 60, 65A and 65B shown in FIGS. 2-7, except for the non-magnetic insulating layers 37a and 47a which are replacements for the non-magnetic metal layers 37 and 47, respectively, of the first embodiment.

Each of the non-magnetic insulating layers 37a and 47a has a film thickness of, for example, 0.2 nm to 2.0 nm, and is formed of an oxide of a material selected from a group consisting of Mg, Al, Ti and Zr. Examples of the oxide include MgO, AlOx, TiOx and ZrOx, where the suffix “x” indicates that the composition may be offset from the compound composition. Among the oxide materials, crystalline MgO is especially suitable for the non-magnetic insulating layers 37a and 47a. Alternatively, each of the non-magnetic insulating layers 37a and 47a may be formed of a nitride or a nitride compound of a material selected from a group consisting of Al, Ti and Zr. Such nitrides include AlN, TiN, and ZrN.

The non-magnetic insulating layers 37a and 47a may be formed directly over the underlying layer by a sputtering method, a CVD method or a vapor deposition method, or alternatively, a metal layer formed over the underlying layer by a sputtering method, a CVD method or a vapor deposition method may be converted to the metal oxide or the metal nitride through an oxidation or nitriding process.

The amount of change in tunnel resistance per unit area is acquired in the same manner as the measurement of ΔRA of the first embodiment representing magnetoresistance change per unit area. The greater the polarizability of the magnetization free layer 38 and the second magnetization pinned layer 36 or 46, the greater the amount of change in tunnel resistance per unit area. In this context, the polarizability is that of the ferromagnetic layer (i.e., the magnetization free layer 38 and the second magnetization pinned layers 36 and 46) via the insulating layer (i.e., non-magnetic insulating layers 37a and 47a). Since the spin-polarization of CoFeGe is as same as that of conventionally used NiFe or CoFe, it is expected that the tunnel resistance change per unit area increases by applying CoFeGe to at least one of the magnetization free layer 38 and the second magnetization pinned layer 36 (or 47), as in the first embodiment. Increase of the tunnel resistance change per unit area can also be expected when the second magnetization pinned layer 36 (or 46) is made of CoFeAl, while applying CoFeGe to the magnetization free layer 38.

The composition range of CoFeGe applied to the magnetization free layer 38 is the same range explained in conjunction with the first embodiment, and it is within the area defined by the lines connecting coordinate points A, B, C and D shown in FIG. 9. By setting the composition range in this area, a high-output magnetoresistive device can be realized with a TMR film.

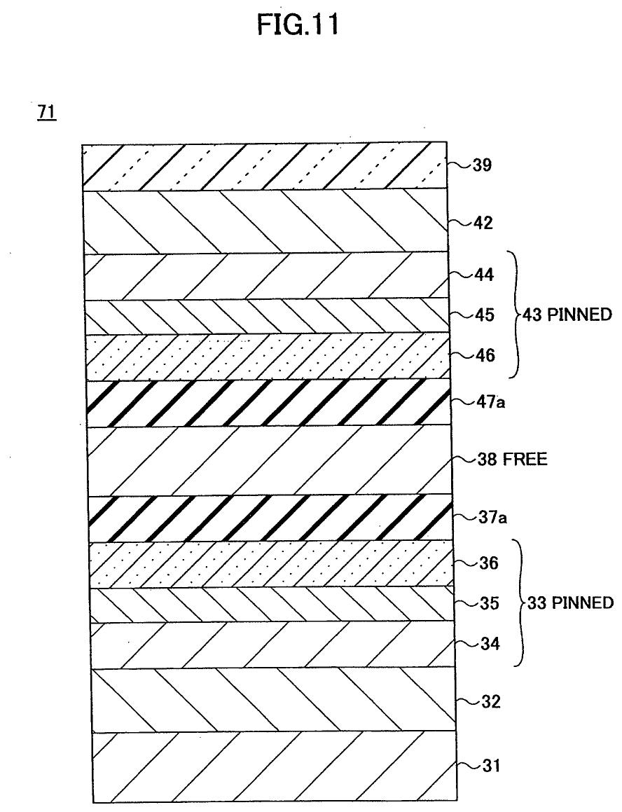

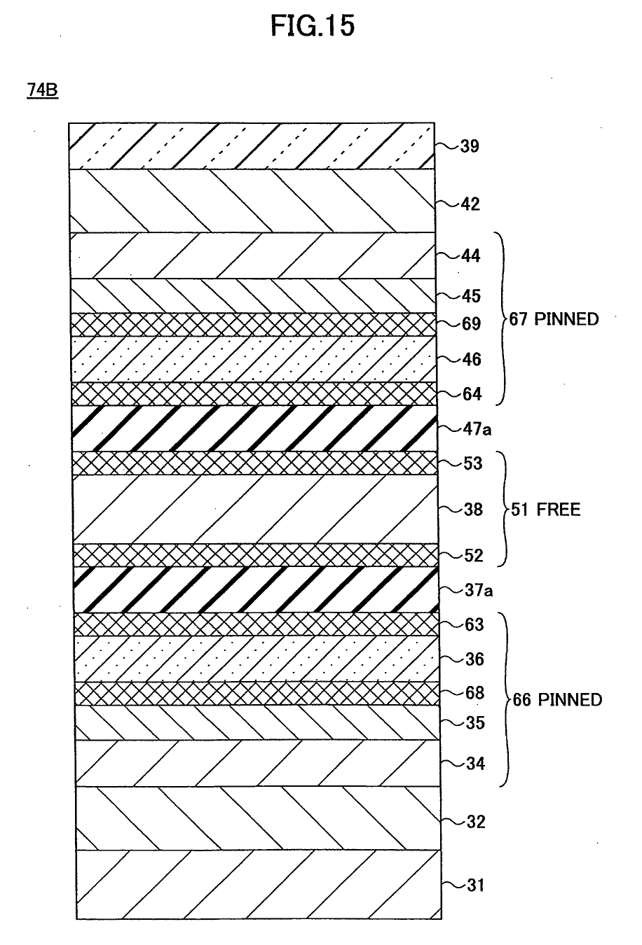

In the second embodiment, the TMR films 72, 73, and 74A of the structural examples 3-5 are modifications of the TMR film 71 of the structural example 2 shown in FIG. 11. Such a dual spin valve TMR structure may be applied to the magnetization free layer 38 and/or the second magnetization pinned layer 36 of the TMR film 70 shown in FIG. 10. In addition, the TMR film 72 of structural example 3 and the TRM film 74A of structural example 5 may be combined to create the TRM film 74B of structural example 6 shown in FIG. 15, which combination can achieve the optimum output level.

### Third Embodiment

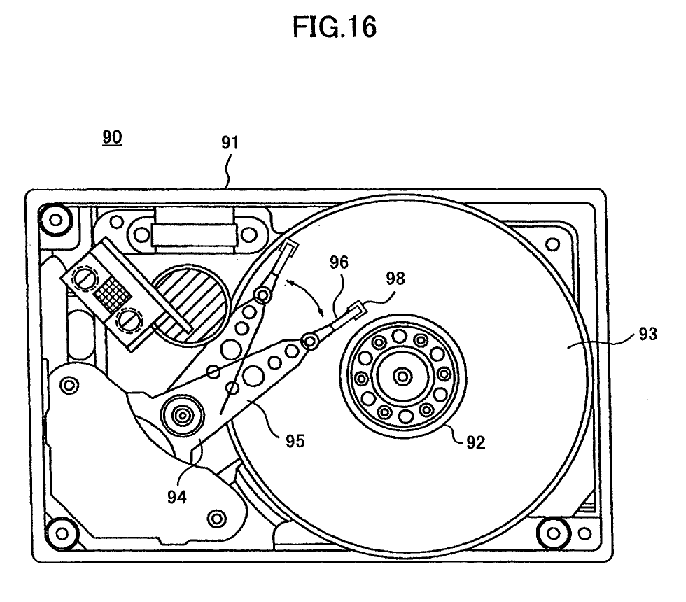

FIG. 16 is a plan view of a magnetic storage apparatus according to the third embodiment of the present invention. The magnetic storage apparatus 90 has a housing 91 which accommodates a hub 92 driven by a spindle (not shown), a magnetic recording medium 93 fixed to the hub 92 and rotated by the spindle, an actuator unit 94, a suspension supported by the actuator unit 94 and driven in a radial direction of the magnetic recording medium 93, and a magnetic head 98 supported by the suspension 96.

The magnetic recording medium 93 can be of an in-plane magnetic recording type or a perpendicular magnetic recording type, and may be a recording medium having oblique anisotropy. The magnetic recording medium 93 is not limited to a magnetic disk, and can be a magnetic tape.

The magnetic head 98 includes the magnetoresistive device 20 and the induction type writing device 13 formed over the ceramic substrate 11, as illustrated in FIG. 1. The induction type writing device 13 may be a ring type for in-plane recording, a single magnetic-pole type for perpendicular recording, or any known types. The magnetoresistive device 20 has any one of the GMR films of structural examples 1-6 of the first embodiment, or it may have any one of the TMR films of structural examples 1-5 of the second embodiment. In either case, the magnetoresistive device 20 has a sufficient amount of change in magnetic resistance per unit area (ΔRA), or a large amount of change in tunnel resistance, to achieve a high output level. The magnetic storage apparatus 90 is suitable for high-density recording. It should be noted that the basic structure of the magnetic storage apparatus of the third embodiment is only an example and is not limited to the example shown in FIG. 16.

### Fourth Embodiment

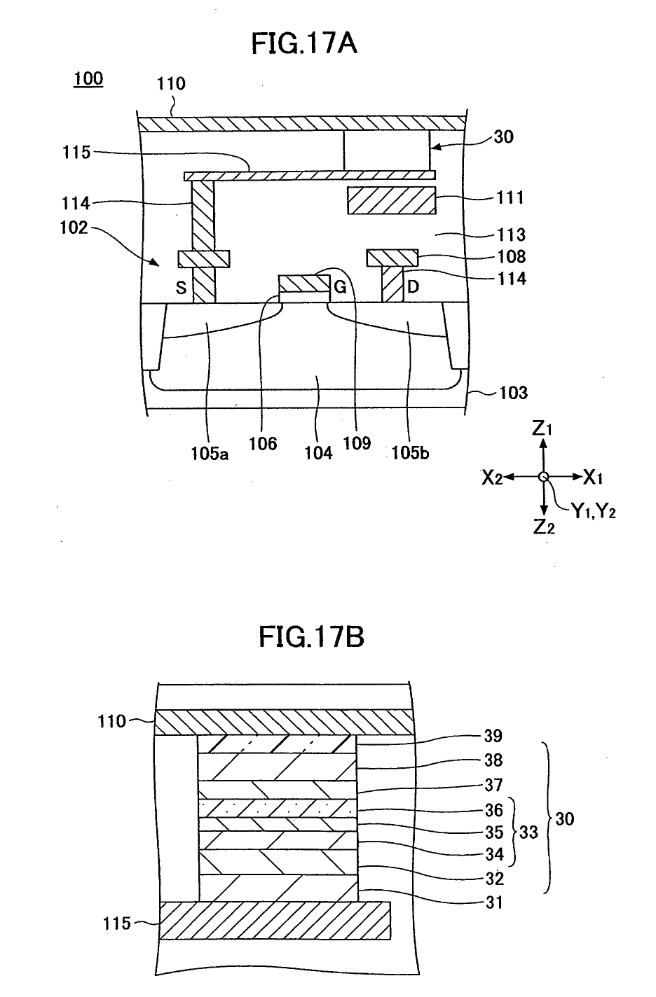

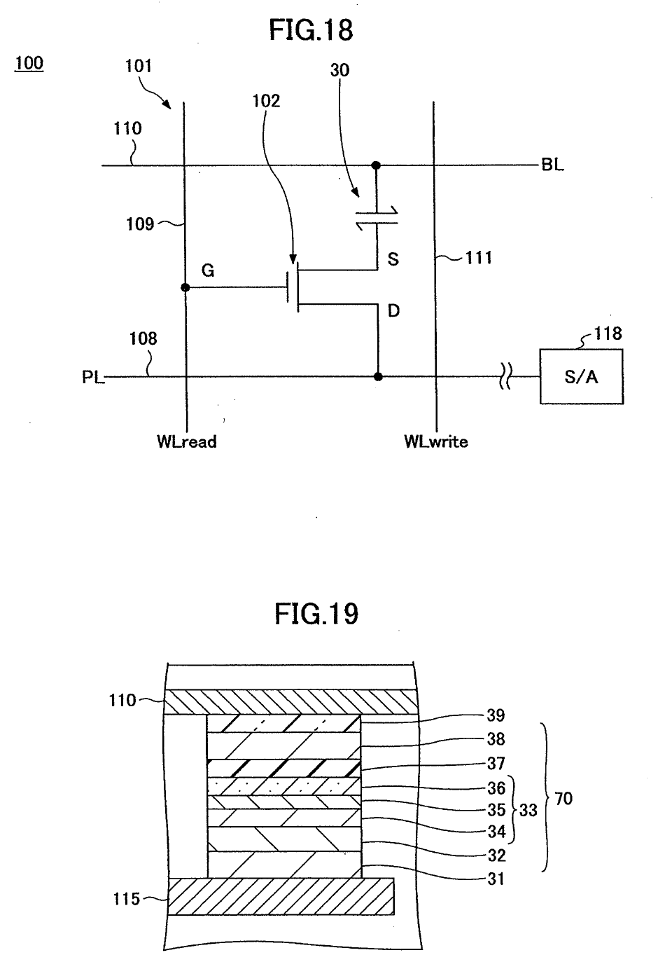

FIG. 17A is a cross-sectional view of a magnetic memory device of structural example 1 of the fourth embodiment. FIG. 17B is a schematic diagram showing the configuration of the GMR film 30 used in FIG. 17A. FIG. 18 is an equivalent circuit diagram of a memory cell of the magnetic memory device. In FIG. 17A, orthogonal(?) coordinate axes are illustrated in order to indicate directions. The Y1 and Y2 directions are perpendicular to the plane of the paper with the Y1 direction going into the plane of the paper and the Y2 direction coming out of the plane of the paper. In the following descriptions, when a direction is merely referred to as “X direction”, the direction may be either the X1 or X2 direction, and the same applies to the “Y direction” and the “Z direction.” In the figures, the same elements already described in the foregoing are denoted by the same symbols, and explanation for them is omitted.

The magnetic memory device 100 includes plural memory cells 101 arranged in a matrix in this example. Each memory cell 101 includes a magnetoresistive effect (GMR) film 30 and a metal-oxide-semiconductor field effect transistor (MOSFET) 102. A p-channel MOSFET or an n-channel MOSFET may be used for the MOSFET 102. Here, a description is given taking an n-channel MOSFET, in which electrons serve as carriers, as an example. The MOSFET 102 has a p-well region 104 containing a p-type impurity formed in a silicon substrate 103, and impurity diffusion regions 105a and 105b formed, separate from each other, in the vicinity of the surface of the silicon substrate 103 in the p-well region 104, an n-type impurity having been introduced into the impurity diffusion regions 105a and 105b. Here, the impurity diffusion region 105a serves as a source S, and the other impurity diffusion region 105b serves as a drain D. The MOSFET 102 has a gate electrode G formed on a gate insulating film 106 on the surface of the silicon substrate 103 between the two impurity diffusion regions 105a and 105b.

The source S of the MOSFET 102 is electrically connected to one side of the GMR film 30, for example, the foundation layer 31, through a vertical wiring 114a and an in-layer wiring 115. Further, a plate line 108 is electrically connected to the drain D through a vertical wiring 114b. A word line 109 for reading is electrically connected to the gate electrode G. Alternatively, the gate electrode G may also serve as the word line 109 for reading. A bit line 110 is electrically connected to the other side of the GMR film 30, for example, the protection film 39. A word line 111 for writing is provided below the GMR film 30 in isolation therefrom. The GMR film 30 has the same configuration as shown in FIG. 2. In the GMR film 30, the easy magnetization axis and the hard magnetization axis of the magnetization free layer 38 are oriented along the X-axis and Y-axis, respectively, shown in FIG. 17A. The directions of the easy magnetization axis may be formed either by heat treatment or according to shape anisotropy. In the case of forming the easy magnetization axis in the X-axial directions according to shape anisotropy, the shape of a cross section of the GMR film 30 parallel to its film surface (or parallel to the X-Y plane) is caused to be a rectangle having a longer side in the X direction than a side in the Y direction.

In the magnetic memory device 100, the surface of the silicon substrate 103 and the gate electrode G are covered with an interlayer insulating film 113 such as a silicon nitride film or a silicon oxide film. The GMR film 30, the plate line 108, the word line 109 for reading, the bit line 110, the word line 111 for writing, the vertical interconnections 114, and the in-plane interconnections 115 are electrically isolated from each other by the insulating film 113, other than the above-described electrical connections.

The magnetic memory device 100 retains information in the GMR film 30. The retained information represent different values depending on whether the magnetization of the magnetization free layer 38 is parallel or antiparallel to the magnetization of the second magnetization pinned layer 36.

Next, read and write operations of the magnetic memory device 100 are explained. In writing information in the GMR film 30 in the magnetic memory device 100, the bit line 110 and the word line 111 for writing extending above and below the GMR film 30, respectively, are used. The bit line 110 extends in the X direction on the GMR film 30. By applying electric current to the bit line 110, a magnetic field is applied to the GMR film 30 in the Y direction. The word line 111 for writing extends in the Y direction below the GMR film 30. By applying electric current to the word line 111 for writing, a magnetic field is applied to the GMR film 30 in the X direction. The magnetization of the magnetization free layer 38 of the GMR film 30 is in the X direction (for example, the X2 direction) when substantially no magnetic field is applied, and this direction of the magnetization is stable.

In writing information in the GMR film 30, electric current is applied simultaneously to the bit line 110 and the word line 111 for writing. For example, to bring the magnetization of the magnetization free layer 38 in the X1 direction, electric current is applied in the Y1 direction to the write word line 111. As a result, the magnetic field is oriented in the X1 direction in the GMR film 30. At this time, the direction of electric current applied to the bit line 110 may be either the X1 direction or the X2 direction. The magnetic field generated by the current flowing through the bit line 110 is in the Y1 direction or the Y2 direction in the GMR film 30, and functions as a part of the magnetic field for the magnetization of the magnetization free layer 38 to cross the barrier of the hard magnetization axis. That is, as a result of simultaneous application of the magnetic field in the X1 direction and the magnetic field in the Y1 or Y2 direction to the magnetization of the magnetization free layer 38, the magnetization of the magnetization free layer 38 oriented in the X2 direction is reversed to be in the X1 direction. After the magnetic fields are removed, the magnetization of the magnetization free layer 38 remains oriented in the X1 direction, and is stable unless a magnetic field of a next write operation or a magnetic field for erasure are applied.

Thus, “1” or “0” is recorded in the GMR film 30 depending on the direction of the magnetization of the magnetization free layer 38. For example, when the direction of magnetization of the second magnetization pinned layer 36 is the X1 direction, “1” is recorded if the direction of magnetization of the magnetization free layer 38 is the X1 direction (the state of low tunnel resistance) and “0” is recorded if the direction of magnetization of the magnetization free layer 38 is the X2 direction (the state of high tunnel resistance).

The magnitudes of the electric currents supplied to the bit line 110 and the write word line 111 in the write operation are selected such that the current flow supplied to one of the bit line 110 and the word line 111 alone does not reverse the magnetization of the magnetization free layer 38. As a result, recording is performed only in the magnetization of the magnetization free layer 38 of the GMR film 30 at the intersection of the bit line 110 supplied with current and the word line 111 for writing supplied with current. The source S side is set at high impedance so as to prevent a current from flowing through the GMR film 30 at the time of causing current to flow through the bit line 110 in the write operation.

In the read operation of the magnetic memory device 100 performed on the GMR film 30, a negative voltage relative to the source S is applied to the bit line 110, and a voltage higher than the threshold voltage of the MOSFET 102 (a positive voltage) is applied to the read word line 109, that is, the gate electrode G. As a result, the MOSFET 102 is turned on, and electrons flow from the bit line 110 to the plate line 108 through the GMR film 30, the source S, and the drain D. A current sensor 118, such as an ammeter, is electrically connected to the plate line 108 to read the magnetoresistance value corresponding to the direction of magnetization of the magnetization free layer 38 with respect to the magnetization of the second magnetization pinned layer 36. In this manner, information “1” or “0” retained by the GMR film 30 can be read out.

In the magnetic memory device 100 of the structural example 1 of the fourth embodiment, the magnetization free layer 38 of the GMR film 30 is formed of CoFeGe so as to have a large magnetoresistance change ΔRA. This means that the difference between the magnetoresistance values corresponding to the retained “0” and “1” is sufficiently large, and accurate readout operation is secured. Since the composition of CoFeGe used in the magnetization free layer 38 of the GMR film 30 is selected so as to be within the range defined by the area ABCD shown in FIG. 9, the MR ratio is higher than that of Co₅₀Fe₂₅Al₂₅, which is a Heusler alloy composition. The GMR film 30 used in the magnetic memory device 100 may be replaced by any one of the GMR films 40, 50, 60, 65A and 65B of structural examples 2-6 illustrated in FIG. 3 through FIG. 7.

FIG. 19 is a schematic diagram illustrating the structure of the TMR film 70, which is used in place of the GMR film 30 shown in FIG. 17 as a modification of the magnetic memory device 100 of structural example 1. The basic structure of the TMR film 70 has a structure similar to that of the TMR film of the structural example 1 used in the magnetoresistive device of the second embodiment. In the TMR film 70, the buffer layer 31 is in contact with the in-plane interconnection 115, and the protection film 39 is in contact with the bit line 110. Further, the easy magnetization axis of the magnetization free layer 38 is arranged in the same manner as in the above-described GMR film 30. The write operation and the read operation of the magnetic memory device 110 in the case of employing the TMR film 70 are the same as in the case of employing the GMR film 30, and, thus, descriptions thereof are omitted.

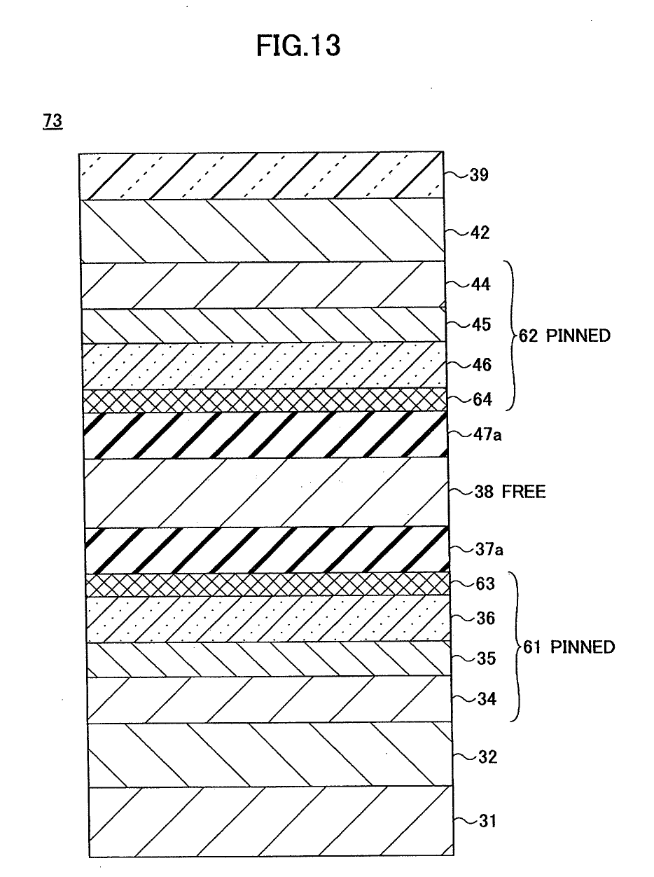

As described in the second embodiment, the TMR film 70 exhibits a tunnel resistance effect. The TMR film 70 shows a large amount of change in the tunnel resistance because the magnetization free layer 38 is formed of CoFeGe with a specific range of composition. Therefore, the magnetic memory device 100 is capable of accurate reading operations with a sufficiently large amount of tunnel resistance change corresponding to the difference between the values “0” and “1” retained in the TMR film. It should be noted that any one of the TMR films of structural examples 2-6 shown in FIG. 13 through FIG. 15 may be used in the magnetic memory device.

By applying CoFeGe with a specific range of composition to the second magnetization pinned layer 36 and/or 46, in addition to or in place of the magnetization free layer 38, similar or greater effect can be achieved.

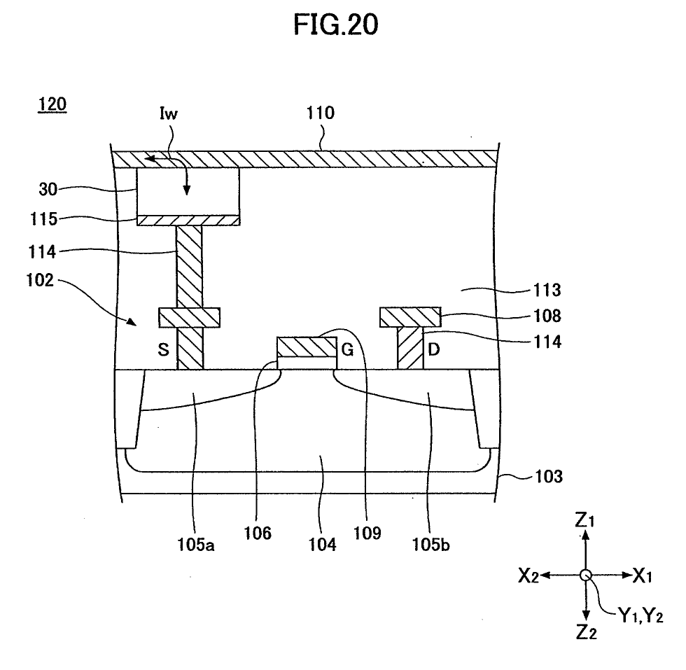

FIG. 20 is a cross-sectional view of a magnetic memory device 120, which is structural example 2 of the magnetic memory device of the fourth embodiment. In FIG. 20, the same elements as those described in the previous example are denoted by the same symbols, and explanation for them is omitted. The magnetic memory device 120 is different from the magnetic memory device 100 of structural example 1 in the mechanism and operation for writing information in the GMR film 30.

The memory cell of the magnetic memory device 120 has the same configuration as the memory cell 101 shown in FIG. 17A and FIG. 17B except that the write word line 111 is not provided. A more detailed explanation is given below with reference to FIG. 20 together with FIG. 17B.

In the write operation of the magnetic memory device 120, spin-polarized current Iw is injected to the GMR film 30. Depending on the direction of the current flow, magnetization of the magnetization free layer 38 is reversed from parallel to antiparallel or from antiparallel to parallel with respect to the magnetization of the second magnetization pinned layer 36. The spin-polarized current Iw is an electron flow with spin magnetic moment oriented in one of the two possible directions electrons can take. By introducing the spin-polarized current Iw to the GMR film 30 in the Z₁ direction or the Z₂ direction of the GMR film 30, a torque is generated in the magnetization of the magnetization free layer 38 to cause so-called spin transfer magnetization reversal. The amount of spin-polarized current Iw is selected appropriately in accordance with the film thickness of the magnetization free layer 38, and it is few mA to 20 mA. The spin-polarized current Iw is less than the electric current flowing through the bit line 110 and the write word line 111 in the write operation of the magnetic memory device of structural example 1 shown in FIG. 17A, and consequently, power consumption can be reduced with the magnetic memory device 120 of structural example 2.

Spin-polarized current can be generated by applying electric current perpendicularly to a multilayer body with a copper (Cu) film sandwiched by a pair of ferromagnetic layers, which structure is similar to that of the GMR film 30. The direction of the spin magnetic moment of electrons can be controlled by setting the magnetization of the two ferromagnetic layers parallel or antiparallel to each other. The read operation of the magnetic memory device 120 is the same as that of the magnetic memory device 100 of structural example 1 shown in FIG. 17A.

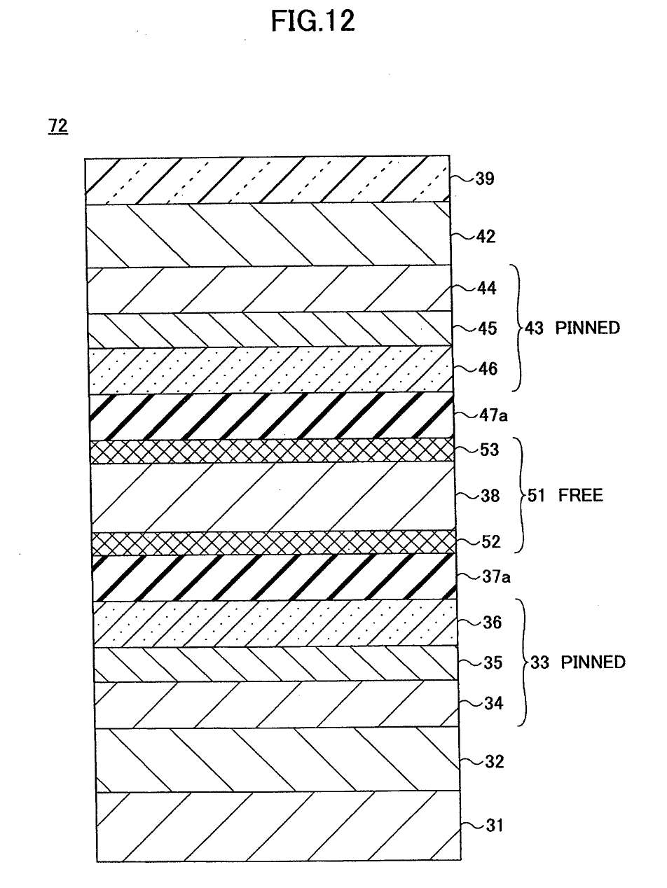

The magnetic memory device 120 of structural example 2 is more advantageous because of the effect of low power consumption, in addition to the effects of the magnetic memory device 100 of the structural example 1. It should be noted that the GMR film 30 of the magnetic memory device 120 may be replaced by any one of the GMR films 40, 50, 60, 65A and 65B of structural examples 2-6 shown in FIG. 3 through FIG. 7, or may be replaced by any one of the TMR films structural examples 1-6 illustrated in FIG. 12 through FIG. 15. Although the direction of current flow is controlled in the read and write operations using a MOSFET in the magnetic memory devices 100 and 120 of structural examples 1 and 2 of the fourth embodiment, any suitable means may be used to control the electric current flow.

By using CoFeGe for at least one of the magnetization free layer and the magnetization pined layer, and by selecting the compositions of the CoFeGe layer within the appropriate range, the amount of change ΔRA in magnetoresistance per unit area can be increased.

Although the description has been made above based on the preferred examples, the invention is not limited to the examples, but include many modifications and substitutions within the scope of the invention defined in the appended claims. For example, the disk shape magnetic recording medium described in the third embodiment may be replaced by a magnetic tape. In this case, the invention is applied to a magnetic tape drive, which is another example of a magnetic storage apparatus. Although in the embodiment, description has been made of the magnetic head furnished with a magnetoresistive device and a writing device, the invention is applicable to a magnetic head with one or more magnetoresistive devices, without a writing device.

The present application is based on Japanese Priority Applications No. 2007-038198 filed Feb. 19, 2007, the entire contents of which are hereby incorporated by reference.

What is claimed is:

1. A magnetoresistive device of a CPP type, comprising:
a magnetization pinned layer;
a magnetization free layer; and
a non-magnetic layer provided between the magnetization pinned layer and the magnetization free layer;
wherein at least one of the magnetization free layer and the magnetization pinned layer is formed of CoFeGe, and
wherein the CoFeGe has a composition falling within a range defined by line segments connecting coordinate points A, B, C, and D in a ternary composition diagram where the point A is (42.5, 30, 27.5), the point B is (35, 52.5, 12.5), the point C is (57.5, 30.0, 12.5), and the point D is (45.0, 27.5, 27.5), and where each of the coordinate points is represented by content percentage of (Co, Fe, Ge) expressed by atomic percent (at. %).

2. The magnetoresistive device as claimed in claim 1, wherein when one of the magnetization free layer and the magnetization pinned layer is formed of CoFeGe, the other is formed of CoFeGe or CoFeAl.

3. The magnetoresistive device as claimed in claim 1, further comprising:
an interfacial magnetic layer inserted between the non-magnetic layer and the CoFeGe layer used in at least one of the magnetization free layer and the magnetization pinned layer.

4. The magnetoresistive device as claimed in claim 1, further comprising:
a symmetrically arranged magnetization pinned layer, the symmetrically arranged magnetization pinned layer and the magnetization pinned layer being symmetric with respect to the magnetization free layer; and
a second non-magnetic layer inserted between the magnetization free layer and the symmetrically arranged magnetization pinned layer;
wherein at least one of the magnetization free layer, the magnetization pinned layer, and the symmetrically arranged magnetization pinned layer is formed of the CoFeGe having said composition.

5. The magnetoresistive device as claimed in claim 4, further comprising:
first and second interfacial magnetic layers;
wherein the magnetization free layer is located between said non-magnetic layer and the said second non-magnetic layer, and
wherein the first interfacial magnetic layer is provided between the magnetization free layer and said non-magnetic layer, while the second interfacial magnetic layer is provided between the magnetization free layer and said second non-magnetic layer.

6. The magnetoresistive device as claimed in claim 3, wherein the interfacial magnetic layer is formed of a magnetic alloy including CoₓFe₍₁₀₀₋ₓ₎ (0≦X≦100 at. %), Ni₈₀Fe, or CoFeAl.

7. The magnetoresistive device as claimed in claim 5, wherein the first and second interfacial magnetic layers are formed of a magnetic alloy including CoₓFe₍₁₀₀₋ₓ₎ (0≦X≦100 at. %), Ni₈₀Fe, or CoFeAl.

8. The magnetoresistive device as claimed in claim 5, wherein the magnetoresistive device has an MR ratio at or above 5.6%.

9. The magnetoresistive device as claimed in claim 1, wherein the CoFeGe has a specific resistance (ρ) ranging from 50 μΩcm to 300 μΩcm, and a spin-dependent bulk scattering coefficient (β) at or above 0.4.

10. The magnetoresistive device as claimed in claim 1, wherein said magnetization pinned layer includes a first magnetization pinned film, a second magnetization pinned film, and a non-magnetic coupling layer provided between the first and second magnetization pinned films.

11. The magnetoresistive device as claimed in claim 10, further comprising:
an interfacial magnetic layer provided between the second magnetization pinned film and said non-magnetic layer,
wherein the second magnetization pinned film of said magnetization pinned layer is located on a side closer to said non-magnetic layer.

12. A magnetic head comprising:
a substrate forming a base of a head slider; and
the magnetoresistive device as claimed in claim 1 formed on said substrate.

13. A magnetic storage apparatus comprising:
a magnetic recording medium; and
a magnetic head configured to read information recorded in the magnetic recording medium, the magnetic head including the magnetoresistive device as claimed in claim 1.

14. A magnetic memory device comprising:
a memory element with a CPP-type magnetoresistive effect film that includes a magnetization pinned layer, a magnetization free layer, and a non-magnetic layer provided between the magnetization pinned layer and the magnetization free layer;
a writing unit configured to orient the magnetization of the magnetization free layer by supplying an electric current to a bit line and a word line to generate a magnetic field applied to the magnetoresistive effect film, or by applying a spin-polarized current to the magnetoresistive effect film; and
a reading unit configured to supply a sense current to the magnetoresistive device to sense an electric resistance,
wherein at least one of the magnetization free layer and the magnetization pinned layer is formed of CoFeGe, and
wherein the CoFeGe has a composition falling within a range defined by line segments connecting coordinate points A, B, C, and D in a ternary composition diagram where the point A is (42.5, 30, 27.5), the point B is (35, 52.5, 12.5), the point C is (57.5, 30.0, 12.5), and the point D is (45.0, 27.5, 27.5), and where each of the coordinate points is represented by content percentage of (Co, Fe, Ge) expressed by atomic percent (at. %).

15. The magnetic memory device as claimed in claim 14, further comprising:
a switching device connected to one end of the memory element;
wherein the bit line is connected to the other end of the memory element.
